(19) United States
(12) Patent Application Publication
(10) Pub. No.: US 2026/0241623 A1
(43) Pub. Date: Aug. 20, 2026

(54) METHOD FOR PRODUCING A MOLDED PART

(71) Applicant: Elkamet Kunststofftechnik GmbH, Biedenkopf (DE)

(72) Inventors: Marco EMRICH, Ulrichstein (DE); Martin NEEBE, Stadtallendorf (DE)

(21) Appl. No.: 19/164,211

(22) PCT Filed: Mar. 1, 2024
(86) PCT No.: PCT/EP2024/055459

§ 371 Date: Sep. 11, 2025

(30) Foreign Application Priority Data
Mar. 14, 2023 (DE) 10 2023 106 355.3

(51) Int. Cl. B29C 45/14; B29C 39/10; B29C 41/04; B29C 41/20; B29K 77/00; B29K 677/00

(52) U.S. Cl. CPC B29C 45/14; B29C 39/10; B29C 41/04; B29C 41/20; B29C 2045/14877; B29K 2077/00; B29K 2677/00

(57) ABSTRACT

A method produces a molded part including a prefabricated insert part, which has a connection region including a first polyamide material, and a molded-part portion. A polymerizable plastic precursor mixture containing a first lactam monomer is introduced into a mold. The plastic precursor mixture is heated to a start temperature, and is polymerized in the mold such that a second polyamide material is formed and the molded-part portion is molded. The insert part is positioned on or in the mold in such a way that the connection region heated to an activation temperature comes in contact with the plastic precursor mixture during the polymerization, the activation temperature being no more than 50° C. lower and no more than 50° C. higher than a first polymer melting temperature of the first polyamide material, whereby a bond forms between the molded-part portion and the connection region.

### CROSS REFERENCE TO RELATED APPLICATIONS

This application is a U.S. National Phase application under 35 U.S.C. § 371 of International Application No. PCT/EP2024/055459, filed on Mar. 1, 2024, and claims benefit to German Patent Application No. DE 10 2023 106 355.3, filed on Mar. 14, 2023. The International Application was published in German on Sep. 19, 2024 as WO 2024/188670 A1 under PCT Article 21(2).

### FIELD

The invention relates to a method for producing a molded part including a prefabricated insert part and a molded-part portion molded onto the insert part; the prefabricated insert part having a connection region including a first polyamide material; the molded part being produced by providing a polymerizable plastic precursor mixture containing at least a first lactam monomer for producing a second polyamide material, introducing the plastic precursor mixture into a mold, heating the plastic precursor mixture to a start temperature T_{S}, and polymerizing the plastic precursor mixture in the mold, at or above the start temperature T_{S}, such that the second polyamide material is formed and the molded-part portion is molded; an inner contour of the mold determining an outer contour of the molded-part portion.

### BACKGROUND

DE 10 2009 040 930 A1 discloses a method of the aforementioned type in which an insert part in the form of a bracing element is connected to the wall of a container during the manufacture of the container. To manufacture the container, the bracing element, which is prefabricated from a thermoplastic material, for example, polyethylene, is secured in a rotational mold, which is then filled with the same plastic material, for example, polyethylene. The rotational mold is set into biaxial rotation and heated. During this process, the wall of the container is formed by thermoplastic primary forming and the bracing element is at least partially enclosed in the plastic material by sintering.

Such a method makes it possible to provide a molded part with a special functional portion, although this functional portion cannot be produced at all or not with the desired structural features or tolerances or in the desired position or orientation in the considered manufacturing process (primary forming process). The special functional portion can nevertheless be obtained by producing it at least separately and, in particular, in another process (e.g., in an injection-molding process or by additive manufacturing) and then using it as a prefabricated insert part in the manufacture of the molded part, the remaining sections or portions of the molded part being molded onto the prefabricated insert part “in situ”, so that the prefabricated insert part forms an integral part of the final molded part.

The drawback, however, is that the advantages of such a method cannot yet be transferred to the production of molded parts where the plastic material intended for the molded-part portion cannot be processed thermoplastically at all or only at the expense of technically and/or economically suboptimal results. This may be the case, for example, if the molded-part portion is to be made of a cross-linked plastic material, in particular of a highly cross-linked plastic (thermosetting plastics), or if the desired plastic material is a thermoplastic material, but has a very high melting temperature, so that the processing temperatures required for thermoplastic primary forming are high and thermoplastic processing is detrimental, for example, because it would damage the plastic itself or adversely affect the life of the mold.

### SUMMARY

In an embodiment, the present disclosure provides a method for producing a molded part including a prefabricated insert part, which has a connection region including a first polyamide material, and a molded-part portion. The method includes providing a polymerizable plastic precursor mixture containing at least a first lactam monomer for producing a second polyamide material and introducing the plastic precursor mixture into a mold. The method further includes heating the plastic precursor mixture to a start temperature, and polymerizing the plastic precursor mixture in the mold, at or above the start temperature, such that the second polyamide material is formed and the molded-part portion is molded, an inner contour of the mold determining an outer contour of the molded-part portion. The insert part is positioned on or in the mold in such a way that the connection region heated to an activation temperature comes in contact with the plastic precursor mixture at least temporarily during the polymerization, the activation temperature being no more than 50° C. lower and no more than 50° C. higher than a first polymer melting temperature of the first polyamide material, whereby a bond forms between the molded-part portion and the connection region of the insert part.

### BRIEF DESCRIPTION OF THE DRAWING

Subject matter of the present disclosure will be described in even greater detail below based on the exemplary FIGURE. All features described and/or illustrated herein can be used alone or combined in different combinations. The features and advantages of various embodiments will become apparent by reading the following detailed description with reference to the attached drawing, which illustrates the following:

FIG. 1 schematically illustrates a molded part according to an embodiment of the invention.

### DETAILED DESCRIPTION

In an embodiment, the invention provides an alternative method for producing a molded part including a prefabricated insert part and a molded-part portion molded onto the insert part. To achieve this, it is provided to no longer rely on a process in which the primary forming of the molded-part portion to be molded onto the insert part is based on thermoplastic processing.

In a method according to an embodiment of the invention, the following method steps are performed:
(a) providing the prefabricated insert part including a connection region including a first polyamide material,
(b) providing a polymerizable plastic precursor mixture containing at least a first lactam monomer for producing a second polyamide material,
(c) heating the connection region to an activation temperature T_{A},
(d) filling the plastic precursor mixture into a mold,
(e) heating the plastic precursor mixture to a start temperature T_{S},
(f) polymerizing the plastic precursor mixture in the mold, at or above the start temperature T_{S}, such that the second polyamide material is formed and the molded-part portion is molded, an inner contour of the mold determining an outer contour of the molded-part portion,
(g) positioning the insert part on or in the mold in such a way that the connection region comes in contact with the plastic precursor mixture at least temporarily during the polymerization,
(h) forming a bond between the molded-part portion and the connection region of the insert part.

In the context of this disclosure, the features of embodiments of the inventive method are also referred to as “method steps” or “steps,” which are identified alphabetically for easier reference. However, it is expressly noted that this does not imply any order of the method steps. Rather, each of the method steps mentioned above or described hereinafter may be performed before and/or during and/or simultaneously with and/or after another step of the method, provided this is technically possible and useful. Reference to a component in the singular form also includes a plurality of such components, provided this is technically possible and useful.

What is important, in addition to the method steps mentioned, is that the activation temperature T_{A} is no more than 50° C. lower than a first melting temperature (polymer melting temperature) T_{P1} of the first polyamide material. In addition, the activation temperature T_{A} is no more than 50° C., preferably no more than 30° C., and very preferably no more than 15° C. higher than the first melting temperature T_{P1}. Particularly preferably, the activation temperature T_{A} is no higher than the first melting temperature T_{P1}. This minimizes or avoids adverse effects, for example in the form of thermal or thermo-oxidative degradation of the first polyamide material and/or in the form of deformation of the connection region or the entire insert part. Preferably, the activation temperature T_{A}, while maintaining one of the above-mentioned maximum values, is no more than 40° C., preferably no more than 30° C., particularly preferably no more than 20° C., and even more preferably no more than 10° C. lower than the first melting temperature T_{P1} of the first polyamide material. Surprisingly, activation temperatures T_{A} below the first melting temperature T_{P1} already provide the prerequisite for a stable bond and, above all, a material-to-material bond between the connection region and the molded-part portion, see steps (f) and (h). This can be attributed to the fact that polymer chains at the heated surface portion of the connection region already gain some mobility, resulting in the formation of a (semi-) interpenetrating network and/or an actual chemical linkage between polymer chains of the two polyamide materials of the prefabricated insert part and the molded part. The first melting temperature T_{P1} can be determined according to ISO 11357-3.

The prefabricated insert part provided in method step (a) may have any technically useful shape and may be formed, for example, as a socket, connection piece, fastening tab, filter bowl, quick-release adapter, coupling, thread, bayonet, flange ring, or as a contoured part. The insert part may be at least partially or even predominantly composed of another plastic or of another material (e.g., metal, ceramic) as long as at least the connection region is composed of the first polyamide material.

The prefabricated insert part and/or the connection region are/is preferably not produced in the mold that is used for producing the molded part. In this case, the production is carried out in a mold other than the one mentioned in steps (d), (f), and (g), or in a manufacturing process without a shaping mold, for example in an additive manufacturing process or by mechanical machining of a semi-finished part. In principle, the connection region or the complete insert part can be manufactured using any of the primary or secondary forming processes known in plastics processing, for example, using an injection-molding process, a 3D printing process, a stationary casting process, a rotational process, a blow-molding process, an extrusion process, or a thermoforming process. Another conceivable production method is by mechanical machining of a semi-finished part. This enables the use of insert parts which are not available through the use of the mold and expands the technical possibilities in the design of the molded part.

The first polyamide material includes at least one plastic material with polyamide bonds in a polymer main chain and/or in polymer side chains. The first polyamide material may include, for example, polyamide 6, polyamide 11, polyamide 12, polyamide 66, or polyamide 69, but also includes in its definition a copolymer or a blend including two or more of the polyamides mentioned.

The first polyamide material preferably has as low a moisture content as possible so as not to disturb the polymerization according to step (f). It is therefore preferred to pre-dry the insert part or the connection region.

The first polyamide material may contain additives or admixtures such as, for example, impact modifiers, reinforcing fillers (glass fibers, carbon fibers, and polymer fibers), non-reinforcing fillers (e.g., calcium sulfate, calcium carbonate, barium sulfate, silicates such as wollastonite, kaolin, mica, hornblende, quartz, glass beads, and PTFE), flame retardants (e.g., phosphorus compounds such as organic phosphates, phosphates, ammonium polysulfates, and halogenated organic compounds), demolding agents (e.g., silicone oils and high-melting waxes), slip agents and lubricants (e.g., paraffinic oils), antistatic agents (e.g., quaternary ammonium salts), agents for increasing the thermal and/or electrical conductivity (carbon black, metals, metal oxides, and carbon nanotubes), dyes, pigments, stabilizers (e.g., UV stabilizers such as benzophenone derivatives, hydrolysis stabilizers such as carbodiimides, polycarbodiimides, anti-oxidants, such as sterically hindered amines and phenols), plasticizers (e.g., adipates and phthalates), anti-blocking agents (e.g., paraffin waxes, polyethylene waxes, and montan waxes), thickening agents (e.g., vinyl aromatic-diene copolymers) and processing additives such as, for example, reaction retarders and nucleating agents such as molybdenum sulfide.

The polymerizable plastic precursor mixture provided in method step (b) may optionally contain, in addition to the first lactam monomer, further components, such as one or more of the additives mentioned above with reference to the first polyamide material. However, in the case of the plastic precursor mixture, only additives which do not inhibit the polymerization are suitable.

The heating of the connection region in method step (c) is preferably carried out prior to contact of the connection region with the plastic precursor mixture. The inventors have found that heating activates the first polyamide material to form a bond to the molded-part portion. The heating of the connection region may be carried out prior to step (g) outside the mold or subsequent to step (g) inside the mold, using a suitable heating device, for example, in the form of a radiant heating element, such as a conventional infrared radiator or a suitable laser source, or a contact heating element. The connection region may also itself be heatable, for example by a resistively or inductively heatable heating element embedded in the first polyamide material of the connection region.

During heating, energy is preferably input, at least predominantly, directly into a surface portion of the connection region that comes into contact with the plastic precursor mixture in step (g). By directly heating the surface that is relevant for the bond to the molded-part portion, the activation temperature T_{A} is reached there in a quick and material-friendly manner. In contrast, an energy input at another point of the insert part is disadvantageous, since the low thermal conductivity of the first polyamide material, which is typical for plastics, requires long heating times and/or considerable local overheating in this case, and can result in damage to the material.

The filling of the plastic precursor mixture into the mold in step (d) may be done prior to, simultaneously with, or subsequent to the heating of the connection region (step (c)). For this purpose, a plastic precursor mixture already provided outside the mold according to step (b) may be filled in. In this case, step (d) takes place subsequent to step (b). Alternatively, the components of the plastic precursor mixture may be filled into the mold either individually and/or in the form of two or more premixes, in each case either in parallel or consecutively. In these cases, where the components are only brought together in the mold, the plastic precursor mixture provided by the filling operation according to step (d) is at the same time also provided in accordance with step (b).

The heating of the plastic precursor mixture according to step (e) may take place subsequent to step (d) within the mold. For this purpose, the mold may be configured to be heatable or may be placed in an oven, for example. Alternatively, the heating of the plastic precursor mixture may take place outside the mold before the plastic precursor mixture heated to the start temperature T_{S} is filled into the mold. In this case, too, the mold is preferably configured to be directly or indirectly heatable, and is preferably preheated to at least the start temperature T_{S} before the plastic precursor mixture is filled in.

The mold may be, for example, a stationary casting mold or a reaction injection mold. In particular, the mold may also be a rotational mold which, during polymerization, rotates at least temporarily about a major axis and preferably also about a second, minor axis intersecting the main axis. In the latter case, the inventive method can also produce a molded part in the form of a hollow body.

During the polymerization of the plastic precursor mixture according to method step (f), the second polyamide material is formed from the first lactam monomer in situ in the mold, the molded-part portion being simultaneously molded. The plastic precursor mixture may be brought to the start temperature T_{S}, which is required for the polymerization to take place at a sufficient rate, either prior to filling it into the mold or only in the mold.

To position the insert part according to method step (g), the insert part may be secured directly or indirectly to the mold, or at least relative to the mold, in such a position and orientation that the connection region of the insert part is exposed in an interior space of the mold. The positioning of the insert part in the mold may be carried out before, while, or after the plastic precursor mixture is filled into the mold.

In method step (h), a bond forms between the molded-part portion being molded in step (f) and the connection region of the insert part. This bond is at least in part a material-to-material bond. Thus, within the scope of embodiments of the invention, there exists a permanent connection through fusion and/or establishment of chemical bonds and/or intermolecular or chemical bonding forces, the permanent connection being held together by atomic and/or molecular forces.

Within the scope of embodiments of the invention, a material-to-material bond is created in the manufacturing process of the molded part during the primary forming of the molded-part portion as it is molded in situ onto the connection region of the insert part. This material-to-material bond is therefore to be distinguished from other material-to-material bonds where two (prefabricated) parts are joined together, namely by adhesive bonding or thermoplastic welding. This is also noticeable in the finished product. For instance, in contrast to adhesive bonding, no additional material (adhesive) is used between the connection region of the insert part and the connecting region of the molded-part portion connected thereto. Unlike in welding, no seam (weld) in the sense of a bead is formed. While in heated-tool welding, for example, beads are formed by “mushrooming” (deformation) of the joining surfaces of the parts being joined, which are pressed against the heated tools and/or against each other, the inventive method makes it possible to manufacture products without such formation of beads.

Some restrictions that limit the combinations of possible joining partners, such as in laser welding, can be avoided by the method according to an embodiment of the invention. For example, in the case of direct laser welding, at least one joining partner must be composed of a material with very high absorptivity to the employed infrared laser light of the diode or Nd:YAG lasers normally used for welding. Therefore, two amorphous and transparent plastics in particular, but also two semicrystalline and translucent but uncolored/natural colored plastics cannot be easily joined together by direct welding. At least one of the two joining partners must then be provided with a corresponding IR or NIR absorber (IR: infrared; NIR: near infrared), either in the form of a surface coating in the joint region or in the form of an additive. The (N)IR absorber must also have as little absorptivity as possible in the visible spectral range (i.e., is substantially colorless). In the case of laser transmission welding, one joining partner must be composed of a material with very high absorptivity to the laser light used, while the material of the second joining partner, through which the radiation passes during transmission welding, must be as transparent as possible to the (N)IR laser light. Two colored plastics can therefore not be easily joined together by transmission welding. This is especially true for pigment-colored plastics, in particular for plastics which are colored black by adding carbon black, for example. In this case, a special, laser-transparent coloring agent must be used for the material of the second joining partner, through which the radiation is to be passed. The aforementioned (color) combinations are available in the method according to an embodiment of the invention without requiring the use of special (N)IR-absorbing additives or (N)IR-transparent coloring agents.

While in thermoplastic welding processes, the respective material of the involved parts to be joined must be locally heated significantly above the respective melting temperature, the first polyamide material of the insert part can be activated already below its melting temperature, so that in the inventive method, the material-to-material bond can be created without locally melting the first polyamide material in the connection region. The differences or similarities in the thermal history of the material of a joined part in the immediate joint region and in a region of the joined part that is spaced apart from the joint region allow conclusions to be drawn about the joining method used. Such differences or similarities can be determined by DSC analysis, for example. Distinguishing between the different joining methods can also be accomplished by microscopically examining cut surfaces or microtome sections through the joint region, for example by means of optical microscopy, fluorescence microscopes, atomic force microscopy (AFM), or scanning electron microscopy (SEM).

The product obtained by the inventive method is the molded part including the insert part and the molded-part portion molded thereon in situ. By providing a connection region made of a (first) polyamide material in step (a) in conjunction with the use of a first lactam monomer in step (b), which polymerizes to a (second) polyamide material, a basic compatibility between the material of the connection region and the material of the molded-part portion is achieved, which enables a good bond.

The method can be carried out, for example, in such a way that, first, the prefabricated insert part is provided and its connection region is brought to the activation temperature T_{A} (method steps (a) and (c)). Then, the insert part is positioned in or on the mold (method step (g)). Concurrently or subsequently, the plastic precursor mixture is provided, brought to the start temperature T_{S}, and filled into the mold, which is preferably preheated to at least the start temperature T_{S} (method steps (b), (e), (d)). The plastic precursor mixture polymerizes in the mold, forming the molded-part portion (method step (f)). At the same time, the bond between the connection region and the molded-part portion is formed (method step (h)). The molded part can then be removed from the mold, in particular after it has cooled down.

Preferably, the plastic precursor mixture contains an anionic catalyst and an activator. In this case, the polymerization is an activated anionic polymerization, which makes it possible to achieve high polymerization rates and short cycle times, so that the method is overall efficient.

In principle, strong bases can be used as the anionic catalyst for the polymerization of lactam monomers. For example, bases based on organometallic compounds, such as sodium alcoholates and sodium amides, can be used as the catalyst. In particular, it is also advantageous to use alkali metals, alkali metal salts of lactams (e.g., sodium caprolactamate), alkali metal alcoholates, alkali metal hydroxides, and, in particular, alkali metal hydrides. Also suitable are alanates according to the formula M[ALHx(OR)4−x]n, where:

$$M = metal of group Ia or IIa of the periodic table ,$$

$$R = CH2CH 2 {OR}^{′} with {R}^{′} = C 1 - C 4 - alkyl ,$$

$$x = 1 to 4 ,$$

$$N = valence of M .$$

Examples of these are Na-bis-(2-methoxy-ethoxy)dihydride alanate or Na-tetra-(ε-caprolactam)alanate.

In principle, all acylating compounds can be used as activators, either directly or after reaction with the respective lactam monomer. These include, for example, acid anhydrides and acid halides (especially acid chlorides), organic peroxides, esters, lactones, ureas, and thioureas as well as linear or cyclic isocyanates such as, for example, hexamethylene-1,6-bis-carbamido-caprolactam, and allophanates, or mixtures of these substances. Low-molecular polymers, often referred to as prepolymers, with N-acyl lactam terminal groups, can also be used. It is especially favorable to use acyl caprolactam, polycarbodiimides, as well as monoisocyanates and polyisocyanates and their derivatives.

Preferably, the start temperature T_{S} (see method step (e)) is at least as high as a monomer melting temperature T_{M1} of the first lactam monomer and at least 10° C. lower than a second melting temperature (polymer melting temperature) T_{P2} of the second polyamide material. The start temperature T_{S} may in particular also be at least 10° C., preferably at least 20° C., more preferably at least 30° C., and particularly preferably at least 40° C. higher than the monomer melting temperature T_{M1}, while maintaining the above-mentioned upper limit. The first lactam monomer is then present in the molten state, the plastic precursor mixture is overall flowable, and the polymerization starts quickly. The monomer melting temperature T_{M1} of the first lactam monomer and the second melting temperature T_{P2} can be determined, for example, by means of differential scanning calorimetry (DSC) according to ISO 11357-3.

In a preferred embodiment, the providing of the plastic precursor mixture according to method step (b) includes the method steps of:
providing a first monomer mixture including the first lactam monomer and an alternative component, which is selected as a component from a group consisting of the two alternatives: catalyst and activator, the first monomer mixture preferably being provided in the form of a first melt,
providing a second monomer mixture including the first lactam monomer and/or a second lactam monomer and including the other alternative component, which is the respective other component from the group consisting of the catalyst and the activator, the second monomer mixture preferably being provided in the form of a second melt alternatively or in addition to the first monomer mixture,
combining the first monomer mixture and the second monomer mixture.

By providing monomer mixtures, in particular in the form of melts, the components of the plastic precursor mixture can be easily handled before it is finally provided, a premature start of the polymerization being avoided by the separation of the catalyst and the activator, which are thus never contained together in a monomer mixture.

The combination of the first monomer mixture and the second monomer mixture may be carried out prior to filling the plastic precursor mixture into the mold, for example in a mixing vessel upstream of the mold. Alternatively, the combination of the first monomer mixture and the second monomer mixture may also be carried out in the mold itself.

In another embodiment of the method, the plastic precursor mixture is maintained at or above a waiting temperature T_{W} for a time (waiting time) t_{W} before the connection region of the insert part first comes into contact with the plastic precursor mixture. The waiting temperature T_{W} is at least as high as the monomer melting temperature T_{M1}, in particular at least as high as the start temperature T_{S}. In other words, the waiting time t_{W} begins when the plastic precursor mixture provided first meets the temperature criterion of reaching the waiting temperature T_{W}, and it ends when the plastic precursor mixture and the connection region first come into contact with each other. During the waiting time, the plastic precursor mixture may have a constant temperature or a time-varying temperature, with a temperature profile having at least one minimum and at least one maximum, the temperature not falling below the waiting temperature T_{W} during the waiting period t_{W}. From a chemical point of view, the start of the waiting time t_{W} marks the time at which all the conditions for the polymerization to start are met, so that the plastic precursor mixture already polymerizes during the waiting time t_{W}. The waiting time t_{W} can therefore also be referred to as pre-polymerization time in the sense of a polymerization before the first contact between the plastic precursor mixture and the connection region. In this respect, the term “plastic precursor mixture” also includes the polymerizing or incipiently polymerized plastic precursor mixture, including portions of oligomers and/or polymers formed or forming in the course of polymerization.

Since the polymerization of lactams is exothermic, the temperature of the polymerizing plastic precursor mixture increases during the waiting time t_{W}, at least when using these monomers. If the plastic precursor mixture spends at least part of the waiting time t_{W} in the mold preheated to a temperature above the start temperature T_{S}, it is additionally heated by the mold during the waiting time t_{W}. In any case, by providing a waiting time t_{W}, the plastic precursor mixture hits the connection region of the insert part at a higher temperature. In this way, the heating thereof to the activation temperature T_{A} is assisted or, if the start temperature T_{S} is below the activation temperature T_{A}, the connection region cools upon first contact at least to a lesser extent than would be the case without waiting time (pre-polymerization time) t_{W}.

The waiting time t_{W} may be at least 10 seconds, preferably at least 30 seconds, in particular at least 90 seconds, more preferably at least 120 seconds. It is advantageous if the waiting time t_{W} is no longer than the time that the plastic precursor mixture takes (from the start of the waiting time t_{W}) to reach a viscosity of 5000 mPa's, preferably to reach a viscosity of 2000 mPa·s, particularly preferably to reach a viscosity of 1000 mPa·s. The viscosity can be determined according to ISO 2555:2018. At such viscosities, embedding the connection region in the polymerizing plastic precursor mixture is readily possible from a rheological point of view. At the same time, the polymerization has not yet proceeded too far, so that a bond can still form between the connection region and the molded-part portion.

The first polyamide material may be cross-linked. Cross-linking of the polymer chains improves the dimensional stability under heat of the connection region. This allows a slightly higher activation temperature T_{A} to be used without causing unacceptable deformation of the connection region.

In a preferred embodiment of the method, the first lactam monomer is a caprolactam or a laurolactam. Caprolactam (melting temperature: approx. 70° C.) is the monomer of polyamide 6 (melting temperature: approx. 218-222° C.), and laurolactam (melting temperature: approx. 150-153° C.) is the monomer of polyamide 12 (melting temperature: approx. 178-182° C.).

Thus, when using the lactams mentioned, the second polyamide material includes or is a polyamide 6 or a copolymer or a blend including polyamide 6 or, respectively, a polyamide 12 or a copolymer or a blend including polyamide 12. These polyamides have good performance characteristics and can be used at relatively high temperatures compared to other thermoplastics.

In a preferred embodiment of the method, the second lactam monomer is a caprolactam or a laurolactam.

In another embodiment of the method, the first melting temperature T_{P1} of the first polyamide material is lower than a second or the second melting temperature T_{P2} of the second polyamide material. In particular, the first melting temperature T_{P1} is at least 15° C. lower, preferably at least 20° C. lower, more preferably at least 25° C. lower, more preferably at least 30° C. lower, more preferably at least 40° C. lower than the second melting temperature T_{P2}. The melting temperatures T_{P1} and T_{P2} can be determined according to ISO 11357-3.

The inventive relations between the first and second melting temperatures T_{P1} and T_{P2} lead to the advantages described below. When the first melting temperature T_{P1} decreases, the absolute activation temperature T_{A}, which is indicated above relative to the first melting temperature T_{P1} and which is the minimum temperature to which the connection region of the insert must be heated in step (c), decreases to the same extent. This makes it easier to activate the connection region to form a bond to the molded-part portion. Further advantages will be become apparent in the context of the exemplary embodiment described below, which, however, is also advantageous independently thereof.

Temperature relations according to embodiments of the invention can be realized by suitable selection of the first polyamide material and the first lactam monomer. For example, starting from ε-caprolactam as the first (and only) lactam monomer, polyamide 6 (melting temperature: approx. 220° C.) forms as the second polyamide material. Polyamide 11 (melting temperature: approx. 190° C.) or polyamide 12 (melting temperature: approx. 180° C.) can then advantageously be used as the first polyamide material. In this respect, copolyamides, such as PA6/66, PA6/12 or PA6/69, in particular, can also be used as the first polyamide material. The melting temperatures of copolymers can be adjusted via their monomer mixing ratio, it being possible to achieve values below the two melting temperatures of the respective homopolymers. For example, the melting temperature of a PA6/12 copolymer with a 50:50 molar mixing ratio of caprolactam monomer to laurolactam monomer is about 138° C.

In another embodiment of the method, a maximum polymerization temperature T_{Pmax} is lower than a second or the second melting temperature T_{P2} of the second polyamide material. The term “polymerization temperature” refers to the temperature of the plastic precursor mixture or of the second polyamide material forming or formed from the plastic precursor mixture during the method.

Such a temperature profile avoids or reduces adverse effects on the second polyamide material (e.g., degradation) and/or the mold (e.g., reduced service life due to repeated large temperature changes). In particular, melting of the second polyamide material being formed during polymerization is minimized or avoided, so that the molded part can be removed from the mold quickly after steps (f) through (h) without an unnecessarily long cooling phase, since the second polyamide material does not reach a melt state and, therefore, no cooling is required, at least not for solidification. This has a beneficial effect on the cycle time and energy efficiency of the method.

In particular in connection with the aforedescribed embodiment, it is advantageous if the first and second melting temperatures T_{P1} and T_{P2} have the preferred temperature relations described further above. This opens a temperature window between the first melting temperature T_{P1} and the second melting temperature T_{P2}, which temperature window makes it easier to sufficiently activate the first polyamide material, whose minimum activation temperature T_{A} depends on the first melting temperature T_{P1}, and at the same time to carry out the method at sufficiently low polymerization temperatures, in particular below the second melting temperature T_{P2}, which is associated with the advantages described above.

In a preferred embodiment of the method, the heating of the connection region is carried out using a heating device, which is preferably disposed on or in the mold. By using the heating device, it is possible to control the heating of the connection region. In addition, this allows the connection region to be reliably heated to a certain temperature via a selectable heating time.

In a further embodiment of the method, the heating device is in contact with the connection region via a contact region during a contact time t_{K} and, at the end of the contact time t_{K}, is moved relative to the connection region, clearing it at least partially for contact with the plastic precursor mixture.

The contact region may be part of a hot die or hot plate of the heating device. Contact heating is particularly efficient and easy to control. The contact time (heating time) depends on the size and mass or heat capacity of the connection region and also on the (setpoint) temperature Tₛₑₜₚₒᵢₙₜ, heat output, size and mass or heat capacity of the heating element, and can be determined for the respective conditions by preliminary tests.

In another embodiment of the method, a setpoint temperature Tₛₑₜₚₒᵢₙₜ of the heating device during the heating of the connection region is no more than 50° C. lower than the first melting temperature T_{P1}. This enables the achievement of the advantages described above with reference to the (minimum) activation temperature T_{A}.

Preferably, the setpoint temperature Tₛₑₜₚₒᵢₙₜ is no more than 40° C., preferably no more than 30° C., preferably no more than 20° C., and more preferably not more than 10° C. lower than the first melting temperature T_{P1}. Very preferably, the setpoint temperature Tₛₑₜₚₒᵢₙₜ is at least as high as the first melting temperature T_{P1}, in particular at least 10° C. higher than the first melting temperature T_{P1}. Higher setpoint temperatures Tₛₑₜₚₒᵢₙₜ generally enable faster heating of the connection region. However, it is advantageous if the setpoint temperature Tₛₑₜₚₒᵢₙₜ is no more than 100° C. higher than the first melting temperature T_{P1}, preferably no more than 80° C. higher, more preferably no more than 65° C. higher.

Favorable ranges for the setpoint temperature Tₛₑₜₚₒᵢₙₜ are therefore limited by any combination of one of the minimum values specified above relative to the first melting temperature T_{P1} with one of the maximum values specified above relative to the first melting temperature T_{P1}.

In the context of the method according to an embodiment of the invention, the formation of the bond between the connection region of the insert part and the molded-part portion is made possible by observing the previously specified minimum values of the setpoint temperature Tₛₑₜₚₒᵢₙₜ. Observing the previously specified maximum values of the setpoint temperature Tₛₑₜₚₒᵢₙₜ prevents damage to the first polyamide material.

In the following, the inventive method will be illustrated with reference to several non-limiting exemplary embodiments, beginning with a description of the respectively used materials and components.

### Examples

A rod made of non-colored polyamide 6 (first polyamide material) and having a diameter of about 7 mm was used as an insert part in each instance. A flat end of the rod formed the connection region. The rod was provided with a centered hole ending at a point spaced 0.5 mm from the flat end at the connection region of the rod to accommodate a temperature sensor connected to a data logger. The temperature sensor could thus be positioned directly at the connection region.

In order to prepare the plastic precursor mixture, first, two monomer mixtures were prepared. The first monomer mixture contained 500 ml of liquid (i.e., molten) ε-caprolactam (moisture content: ≤0.01% by weight), 14 g of an activator preparation (hexamethylene-1,6-bis-carbamido-caprolactam in caprolactam, C20P activator from Brüggemann, Heilbronn), 0.3 g of wax (Licowax E from Clariant Plastics & Coatings GmbH, Frankfurt), and 4 g of flame soot, particle size: <50 μm. The wax was used as a demolding aid. The carbon black was only added to make it easier to examine, on the finished molded part, the transition region between the (uncolored) first polyamide material of the connection region and the (colored) second polyamide material of the molded-part portion formed from the plastic precursor mixture. The second monomer mixture contained 500 ml of liquid ε-caprolactam and 20 g of a catalyst preparation (sodium caprolactamate in caprolactam, catalyst: Addonyl Kat NL from Lanxess, Cologne). The monomer melts were kept at 100° C. in the absence of air and moisture until their use.

The mold used was a stationary casting mold made of aluminum and electrically heatable in a controlled manner. The interior space for receiving the plastic precursor mixture had the shape of an upright cylinder having an inner diameter of 22 mm and a height of 20 mm. Thus, molded parts or molded-part portions formed in this mold were cylinders having a diameter of about 22 and a height of at most 20 mm, depending on the amount of material filled in.

A hot die which is electrically heatable in a controlled manner was used to heat the connection region.

The method described below was performed for each of the exemplary embodiments. The column details refer to Table 1 below, which provides an overview of process parameters and results.

The mold was heated to 165° C., see column (F). The rod, equipped with a temperature sensor, was placed upright with its flat end on the hot die heated to the setpoint temperature Tₛₑₜₚₒᵢₙₜ, see column (B). The rod was fixed relative to the hot die, and the hot die and the rod were surrounded by a shielding element in the contact region to minimize convection losses. Subsequently, measured quantities of the first and second monomer melts at 100° C. were introduced in a ratio of 1:1 into the pre-heated stationary casting mold (coordinated in time with the preceding step and the following step) and quickly mixed and thereby combined to form a plastic precursor mixture, which had a start temperature T_{S} of 100° C., column (E). After the heating time of the connection region had elapsed, column (C), the rod was removed from the hot die (coordinated in time with the preceding step) and fixed in a holder such that it was disposed concentrically in the stationary casting mold and immersed 3 mm deep in the plastic precursor mixture. The molded part was removed from the stationary casting mold 10 minutes after the monomer melts were filled in. At this point, solid polyamide 6 (as the second polyamide material) had formed from the liquid plastic precursor mixture in the form of the second molded-part portion, in which the connection region of the rod was embedded.

Subsequently, the strength of the bond between the rod and the molded-part portion formed from the plastic precursor mixture and molded onto the end of the rod was determined using a tensile testing machine. For this purpose, the molded part produced in the process was fixed, at the free end of the rod and at the cylindrical molded-part portion, in corresponding receiving elements and subjected to an increasing tensile force until either necking or rupture occurred in the region of the rod or the connection region separated from the molded-part portion. The maximum tensile force reached is shown in column (G).

TABLE 1

| | | | (D) | | | |
|---|---|---|---|---|---|---|
| | | | Temperature of | (E) | (F) | |
| | | | the connection | Start | Temperature of | |
| | (B) | (C) | region at the end | temperature | the mold at the | |
| | Setpoint | Heating | of the heating | T_{S} of the | introduction of | (G) |
| | temperature | time of the | time | plastic | the plastic | Maximum |
| (A) | Tₛₑₜₚₒᵢₙₜ | connection | (=activation | precursor | precursor | tensile force |
| Example | hot die | region | temperature T_{A}) | mixture | mixture | reached |
| No. | ° C. | s | ° C. | ° C. | ° C. | kN |
| 1 | 200 | 210 | 175 ± 2 | 100 | 165 | 2.2 ± 0.3 |
| 2 | 210 | 210 | 185 ± 2 | 100 | 165 | 2.4 ± 0.2 |
| 3 | 220 | 210 | 195 ± 2 | 100 | 165 | 2.6 ± 0.05 |
| 4 | 240 | 210 | 220 ± 3 | 100 | 165 | 2.6 ± 0.06 |
| 5 | 260 | 210 | 225 ± 3 | 100 | 165 | 2.6 ± 0.04 |
| 6 | 280 | 210 | 235 ± 3 | 100 | 165 | 2.6 ± 0.04 |
| R1 | — | — | Room | 100 | 165 | No bond |
| | | | temperature | | | |
| R2 | 100 | 210 | 78 ± 2 | 100 | 165 | <0.2 . . . 0.4 |

The waiting time t_{W} (pre-polymerization time) between the mixing of the monomer mixtures in the stationary casting mold and the first contact of the rod with the plastic precursor mixture was approximately 10 seconds in each instance.

The polymerization temperature, i.e., the temperature of the plastic precursor mixture or of the second polyamide material forming or formed therefrom, remained below about 190° C. (T_{Pmax}≈190° C.) during the entire process and thus significantly below the melting temperature T_{P2} of the second polyamide material (polyamide 6).

In each of the examples 1 through 6 and R1 and R2 illustrated in Table 1, five process runs were carried out with identical parameters. The activation temperature T_{A}, column (D), and the results regarding the strength of the bond between the insert part and the molded-part portion, column (G), are each shown as mean values in Table 1. Reference examples R1 and R2 relate to methods not in accordance with the invention, where no stable bond was achieved between the connection region (flat end of the rod) and the molded-part portion produced in the stationary casting mold. The embodiments of the method according to the invention allow production of stable molded parts, see Examples 1 through 6, column (G).

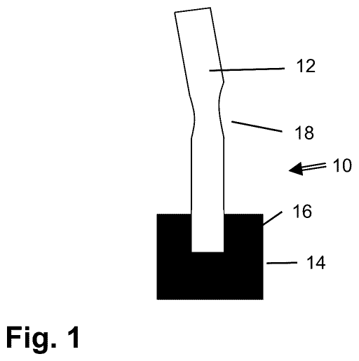

A molded part 10 produced according to the above-described method at a hot die temperature Tₛₑₜₚₒᵢₙₜ of 220° C. (i.e., according to Example No. 3) is shown FIG. 1 in a substantially axial sectional view after the above tensile test was carried out. Molded part 10 includes the (uncolored) prefabricated insert part 12 in the form of a rod and the molded-part portion 14 (colored black). Connection region 16 of insert part 12 is embedded in the material of molded-part portion 14 and bonded to molded-part portion 14. Rod 12 has a neck 18 resulting from the load applied during the tensile test.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for producing a molded part including a prefabricated insert part, which has a connection region including a first polyamide material, and a molded-part portion, the method comprising:
providing a polymerizable plastic precursor mixture containing at least a first lactam monomer for producing a second polyamide material;
introducing the plastic precursor mixture into a mold; and
heating the plastic precursor mixture to a start temperature, and polymerizing the plastic precursor mixture in the mold, at or above the start temperature, such that the second polyamide material is formed and the molded-part portion is molded, an inner contour of the mold determining an outer contour of the molded-part portion,
wherein the insert part is positioned on or in the mold in such a way that the connection region heated to an activation temperature comes in contact with the plastic precursor mixture at least temporarily during the polymerization, the activation temperature being no more than 50° C. lower and no more than 50° C. higher than a first polymer melting temperature of the first polyamide material, whereby a bond forms between the molded-part portion and the connection region of the insert part.

2. The method as recited in claim 1, wherein the plastic precursor mixture contains a catalyst and an activator.

3. The method as recited in claim 1, wherein the start temperature is at least as high as a monomer melting temperature of the first lactam monomer.

4. The method as recited in claim 2, wherein the providing of the plastic precursor mixture is accomplished using the following steps:
i. providing a first monomer mixture including the first lactam monomer and an additive composed of one of two alternative components of catalyst or activator,
ii. providing a second monomer mixture including the first lactam monomer and/or a second lactam monomer and an additive composed of the other one of the two alternative components of catalyst or activator,
iii. combining the first monomer mixture and the second monomer mixture.

5. The method as recited in claim 3, wherein the plastic precursor mixture is maintained at or above a waiting temperature for a time of at least 10 seconds, before the connection region of the insert part first comes into contact with the plastic precursor mixture, and wherein the waiting temperature is at least as high as the monomer melting temperature, and/or at least as high as the start temperature.

6. The method as recited in claim 1, wherein the first lactam monomer is a caprolactam or a laurolactam.

7. The method as recited in claim 4, wherein the second lactam monomer is a caprolactam or a laurolactam.

8. The method as recited in claim 1, wherein the first polymer melting temperature is lower than a second polymer melting temperature of the second polyamide material.

9. The method as recited in claim 1, wherein a maximum polymerization temperature is lower than a second polymer melting temperature of the second polyamide material.

10. The method as recited in claim 1, wherein the heating of the connection region is carried out using a heating device disposed on or in the mold.

11. The method as recited in claim 10, wherein the heating device is in contact with the connection region via a contact region during a contact time and, at the end of the contact time, is moved relative to the connection region, clearing it at least partially for contact with the plastic precursor mixture.

12. The method as recited in claim 10, wherein a setpoint temperature of the heating device during the heating of the connection region is no more than 50° C. lower than the first polymer melting temperature of the first polyamide material.

13. The method as recited in claim 3, wherein the start temperature is at least 10° C. higher than the monomer melting temperature, and at least 10° C. lower than a second polymer melting temperature of the second polyamide material.

14. A method for producing a molded part including a prefabricated insert part, which has a connection region including a first polyamide material, and a molded-part portion, the method comprising:
providing a polymerizable plastic precursor mixture containing at least a first lactam monomer for producing a second polyamide material;
introducing the plastic precursor mixture into a mold; and
heating the plastic precursor mixture to a start temperature, and polymerizing the plastic precursor mixture in the mold, at or above the start temperature, such that the second polyamide material is formed and the molded-part portion is molded, an inner contour of the mold determining an outer contour of the molded-part portion,
wherein the insert part is heated by a heating device and is positioned on or in the mold in such a way that the connection region comes in contact with the plastic precursor mixture at least temporarily during the polymerization, a setpoint temperature of the heating device being no more than 50° C. lower and no more than 100° C. higher than a first polymer melting temperature of the first polyamide material, whereby a bond forms between the molded-part portion and the connection region of the insert part.

15. The method according to claim 14, wherein the heating device is disposed on or in the mold so as to heat the connection region.

16. The method of claim 14, wherein the heating device is a radiant heating element.

17. The method as recited in claim 14, wherein the heating device is in contact with the connection region via a contact region during a contact time and, at the end of the contact time, is moved relative to the connection region, clearing it at least partially for contact with the plastic precursor mixture.

18. The method as recited in claim 17, wherein the contact region is part of a hot die or hot plate of the heating device.

19. The method of claim 14, wherein the heating device is a resistively or inductively heatable heating element embedded in the first polyamide material of the connection region.

20. The method of claim 14, wherein the setpoint temperature is at least 10° C. higher, but no more than 65° C. higher, than the first polymer melting temperature of the first polyamide material.
